(19) United States
(12) Patent Application Publication
(10) Pub. No.: US 2013/0333844 A1
(43) Pub. Date: Dec. 19, 2013

(54) ELECTROSTATIC CHARGE APPLICATOR, THE ELECTROSTATIC CHARGE APPLICATOR HAVING AN ACCUMULATING MEMBER AND AN APPLICATION MEMBER AND A SYSTEM FOR ELECTROSTATICALLY SUPPORTING AN OBJECT

(71) Applicant: Alexander Mayorkis, Foster City, CA (US)

(72) Inventor: Alexander Mayorkis, Foster City, CA (US)

(21) Appl. No.: 14/002,187

(22) PCT Filed: Mar. 2, 2012
(86) PCT No.: PCT/US12/27358

§ 371 Date: Aug. 29, 2013

Related U.S. Application Data
(60) Provisional application No. 61/449,103, filed on Mar. 4, 2011.

(51) Int. Cl. B32B 37/00

(52) U.S. Cl. CPC B32B 37/0046
USPC 156/379.6

(57) ABSTRACT

There is provided an electrostatic support applicator, which comprises a body including: a first body portion and a second body portion; the first body portion including an electrostatic generating sub-assembly; the second body portion being implemented as an accumulating member for accumulating electrostatic charge; and an application member mounted onto said accumulating member and spaced away from said accumulating member by a separating distance “d”, said separating distance “d” being within an electric field of said accumulating member such that said application member gets charged from said accumulating member, when in use, by means of corona discharge.

### FIELD OF THE INVENTION

The present invention generally relates to, but is not limited to, an electrostatic support applicator and more specifically the present invention relates to, but is not limited to, to an electrostatic charge applicator, the electrostatic charge applicator having an accumulating member and an application members and a system for electrostatically supporting an object.

### BACKGROUND OF THE INVENTION

It is known in the art to apply various items on a substantially-vertical support structure. For example, it is known to mount pictures, posters and the like onto a wall. This is done for both personal and commercial use. Numerous means to attach such items onto the substantially-vertical support structures have been proposed in the art. Generally speaking, numerous mechanical means have been proposed—nails, bolts, glue, Scotch® tape and the like. It is also known to apply items to the free-standing support structures by employing electrostatic force. For example, it is known to use static cling vinyl decorations, commonly sold as novelties, which vinyl decorations can support themselves electrostatically on a window or the like.

U.S. Pat. No. 5,638,249 Rubino, et al. On Jun. 10, 1997 teaches an electrostatic support system for applying posters and the like in a removable fashion on wall surfaces using a thin film or foam layer of dielectric backing and a hand-held high voltage charger suitable for creating corona charged particles. The system and method provide a practical, simple and inexpensive manner of mounting displays which may be easily removed and repositioned without damage to the wall surface.

U.S. Pat. No. 3,440,750 issued to Toyh et al. on Apr. 29, 1969 teaches an amusement and display apparatus in which three-dimensional characters of plastic foam are removably secured onto a rigid board by static electricity.

U.S. Pat. No. 4,225,369 issued to Felchlin on Sep. 30, 1980 teaches a method of securing a sheet or a poster to a base, wherein the sheet or poster is brought into contact with at least one plastics material sheet and caused to adhere to said base by dampening said base or by wiping said base on the poster side with a means suitable for producing an electrostatic charge. In one particular application two plastics material sheets joined together along one edge and folded along said edge so as to be superposed one on the other are utilized, said sheet or poster being placed between or on said superposed sheets, said superposed sheets being caused to adhere to one another by being wiped with means suitable for producing an electrostatic charge.

U.S. Pat. No. 4,275,112 issued to Savage, Jr. on Jun. 23, 1981 teaches decorative hanging, electrostatically adherent to wall and ceiling surfaces comprises a doubly charged, irradiated and crosslinked insulative plastic foam.

U.S. Pat. No. 4,741,119 issued to Baryla on May 3, 1988 teaches a display board for displaying, behind a transparent window, a sheet document such as a paper document clinging electrostatically on the surface of a dielectric plastic backing board. The sheet document is covered by a sheet of transparent thin film plastic, preferably provided with a display window with a contrasting border or matte, which also tends to cling electrostatically against the sheet document with the result that the sheet document is sandwiched between the backing board and the sheet of transparent plastic film.

U.S. Pat. No. 4,992,121 issued to Rubino on Feb. 12, 1991 teaches a method of adhering a relatively heavy sheet or three-dimensional object to a support surface using an electrostatically chargeable intermediate sheet, including providing a sheet which is capable of carrying a charge sufficient to support at least three ounces per square foot of intermediate sheet surface for at least one month and charging the sheet using a contaminant free buffer material selected from the group consisting of wool, natural fiber, artificial fiber and chamois. A decorative hanging including such an intermediate sheet is also disclosed.

U.S. Pat. No. 7,815,484 issued to Kriman, et al. on Oct. 19, 2010 teaches an electrostatic toy has a levitating object; and an electrostatic wand which causes levitation of the object and is provided with an electrostatic generator that charges the wand and is operatable by one hand of a user.

### SUMMARY OF THE INVENTION

According to a first broad aspect of the present invention, there is provided an electrostatic support applicator, which comprises a body including: a first body portion and a second body portion; the first body portion including an electrostatic generating sub-assembly; the second body portion being implemented as an accumulating member for accumulating electrostatic charge; and an application member mounted onto said accumulating member and spaced away from said accumulating member by a separating distance “d”, said separating distance “d” being within an electric field of said accumulating member such that said application member gets charged from said accumulating member, when in use, by means of corona discharge.

According to a second broad aspect of the present invention, there is provided a retrofit kit comprising an application member and a support; the support for mounting the application member, in used, onto an electrostatic charge separating member having a portion conducive to generating corona discharge, in use, such that the application member is spaced away from the accumulating member by a separating distance “d”, said separating distance “d” being within an electromagnetic field of the accumulating member such that said application member gets charged from the accumulating member, when in use, by means of corona discharge.

These and other aspects and features of non-limiting embodiments of the present invention will now become apparent to those skilled in the art upon review of the following description of specific non-limiting embodiments of the invention in conjunction with the accompanying drawings.

### DESCRIPTION OF THE DRAWINGS

A better understanding of the embodiments of the present invention (including alternatives and/or variations thereof) may be obtained with reference to the detailed description of the embodiments along with the following drawings, in which:

FIG. 1 depicts a perspective view of an electrostatic support applicator in an assembled state, the electrostatic support applicator being implemented in accordance with a non-limiting embodiment of the present invention.

FIG. 2 depicts a perspective view of the electrostatic support apparatus of FIG. 1, the electrostatic support applicator being in an unassembled state.

FIG. 3 depicts a front sectional view of the electrostatic support applicator of FIG. 1.

FIG. 4 depicts a front sectional view of a portion an electrostatic support applicator implemented in accordance with another non-limiting embodiment of the present invention.

FIG. 5 depicts a perspective view of a portion of a support used within the electrostatic support applicator of FIG. 1, implemented in accordance with a non-limiting embodiment of the present invention.

FIG. 6 depicts a front planar view of a second portion and an installed support thereon, both implemented in accordance with a non-limiting embodiment of the present invention.

FIG. 7 depicts a perspective view of a portion an electrostatic support applicator implemented in accordance with another non-limiting embodiment of the present invention.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF EMBODIMENTS

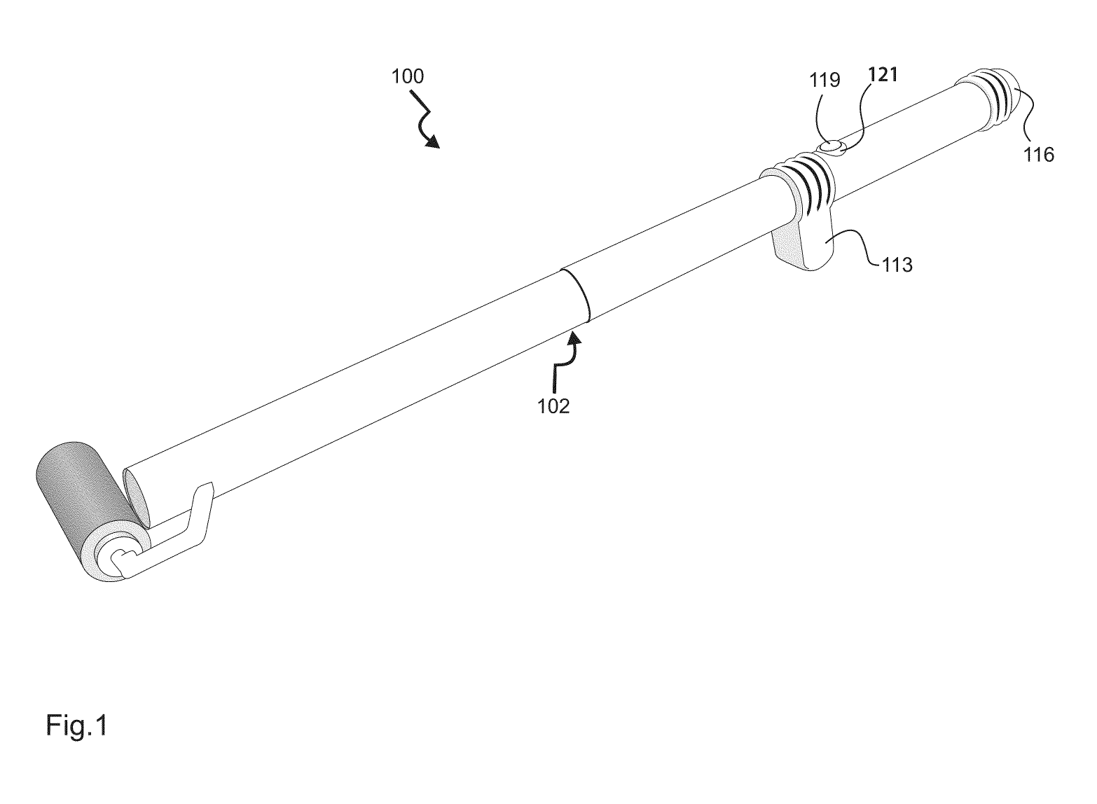

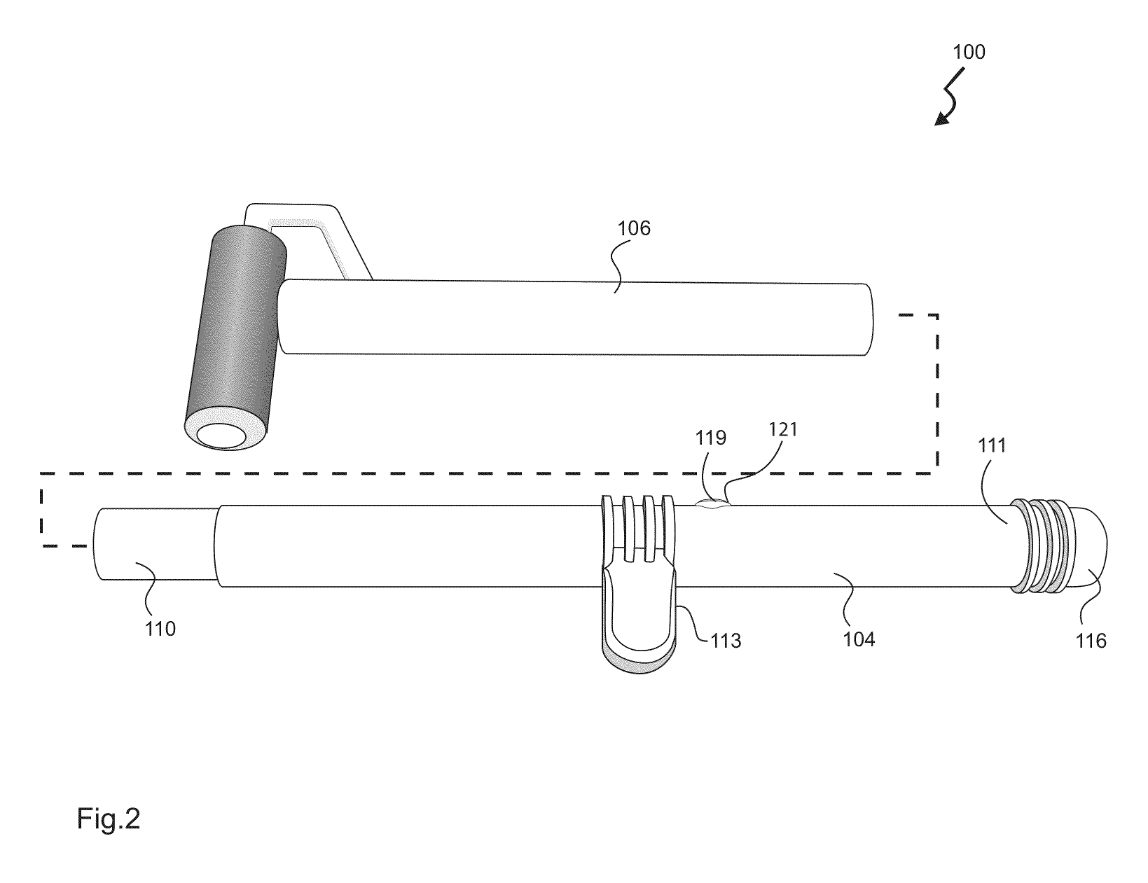

According to embodiments of the present invention, there is provided an electrostatic support applicator, depicted generally in FIG. 1 at 100. FIG. 1 depicts a perspective view of the electrostatic support applicator 100 in an assembled state. Reference shall also be made to FIG. 2, which depicts a perspective view of the electrostatic support applicator 100 in an un-assembled state.

In the illustrated embodiment, the electrostatic support applicator 100 comprises a body 102, which in turn is made up of two parts or “portions”—a first body portion 104 and a second body portion 106. However, in alternative embodiments not depicted in FIG. 1 and FIG. 2, the body 102 can be implemented as a unitary structure or, alternatively, can have more than two portions assembled into the assembled state similar to what is depicted in FIG. 1. In other words, the first body portion 104 and the second body portion 106 can be either (i) made of separate components and be detachably coupled therebeween (which can be two or more portions) or (ii) be made of a unitary component.

As more clearly visible in FIG. 2, the first body portion 104 has a connecting end 110, which is of a diameter smaller than the rest of the first body portion 104 and that of the second body portion 106. The connecting end 110 is receivable within the second body portion 106 (which is substantially hollow inside) in an interference fit arrangement for releasable retention therein, as depicted in FIG. 1. Other couplings are, of course possible, such as a screw in connection, snap on connection and the like.

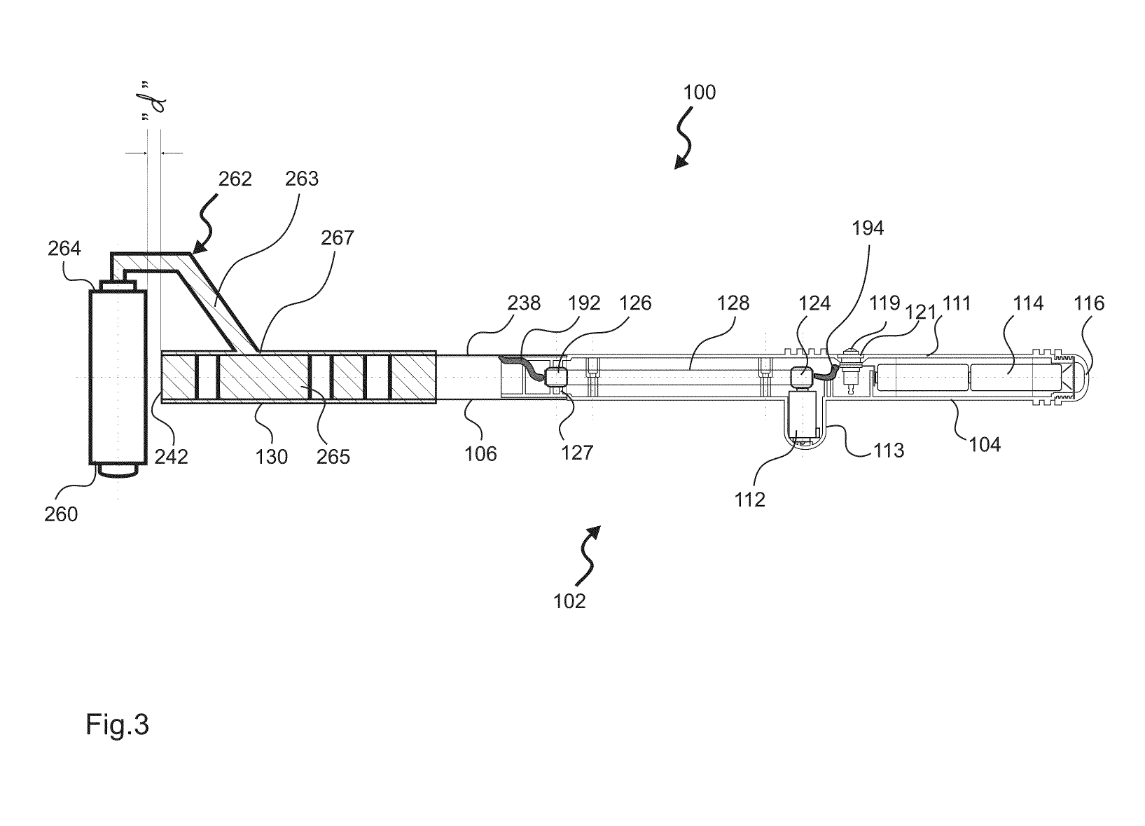

With continued reference to FIG. 1 and FIG. 2, and reference to FIG. 3, which FIG. 3 depicts a cross section along an operational axis of the electrostatic support applicator 100 in an assembled state.

The first body portion 104 comprises a housing 111. The housing 111 can be made of plastic or any other suitable material. Generally speaking, the first body portion 104 may be implemented to house any kind of electrostatic generator. In a specific embodiment to be depicted herein below, the first body portion 104 can be configured to house a Van de Graaff generator. However, in alternative embodiments of the preset invention, the first body portion 104 can be configured to house a piezo-electric generator, and other types of generators similar to those used, for example, in air ionizators, purifiers, electrostatic loudspeakers, electrostatic spraying and flocking devices.

Within embodiments of the present invention, the voltage required to fulfill the purpose of the electrostatic charging of the materials for adhesion, as will be described below, can be as low as 2 kV and above. Inventors have appreciated, that in some embodiments of the present invention, the required voltage can be at least approximately 10 kV and above. It should be noted that other voltage can be used in other embodiments of the present invention.

The housing 111 contains a motive member 112 and a source of power 114 for powering the motive member 112. In the illustrated embodiment, the motive member 112 is housed in a body appendix 113. The body appendix 113 is oriented in a “T-arrangement” vis-à-vis the orientation of the housing 111 As such, in alternative embodiments of the present invention, the motive member 112 can be placed in a different configuration, such as in-line with the source of power 114, for example.

In the illustrated embodiment, the motive member 112 is implemented as an electric motor and the source of power 114 is implemented as at least one battery and, more specifically, a set of two AA batteries. The type of the electric motor used is not limited and, as such, the motor can be implemented as an AC motor, a DC motor, brushless motor, servo motor or the like. Similarly, in alternative embodiments, the source of power 114 can comprise a different type of batteries or may be implemented as a cord that can be plugged into a power outlet, for example.

In the illustrated embodiment, there is also provided a cover 116, which can be releasably attached to the housing 111 for selectively opening the interior of the housing 111 (to insert or replace the source of power 114, for example) and closing the interior of the housing 111 (to maintain the source of power 114 in an operational configuration). In the illustrated configuration, the cover 116 is attached to the rest of the first body portion 104 through a screw-tip connection.

It should be noted that in alternative embodiments, the source of power 114 (i.e. the batteries at the like) can be inserted from a side of the first body portion 104 or in any other suitable manner. Alternatively, the source of power 114 can be housed in a detachable plate (not depicted) made to fit a portion of the first body portion 104 and to be attached to the first body portion 104 with screws or in a snap on connection.

Also provided, within the housing 111 are a switch button 119 housed within a gasket 121. Generally speaking, the function of the switch button 119 is to switch the electrostatic support applicator 100 on (when the switch button 119 is depressed) or off (when the switch button 119 is released). It is noted that the gasket 121 can be used for grounding, through a body of a user, as will be described in greater detail herein below. In alternative embodiments of the present invention, a number of alternative ways to ground the electrostatic support applicator 100 can be used.

Provided in accordance with non-limiting embodiments of the present invention and operatively coupled to the motive member 112 is a first roller 124 (for example, by means of the first roller 124 being mounted on a first support axle (not visible) coupled to the motive member 112 or by any other suitable means). There is also provided a second roller 126 provided within the housing 111 at a location remote from the first roller 124, which is in this example, more proximate to the second body portion 106. The second roller is mounted on a second support axle 127, which allows for rotational movement thereof.

Provided between the first roller 124 and the second roller 126 is a belt 128. When in use (i.e. when the switch button 119 is depressed), with the motive member 112 providing motive power, the first roller 124 rotates and drives the belt 128. It is noted that in various embodiments of the present invention, the belt 128 can be made or rubber, latex, silk or other suitable materials.

Therefore, within embodiments of the present invention, the first roller 124, the second roller 126 and the belt 128 can be considered to be an “electrostatic charge separating member”, which is configured to separate/generate the electrostatic charge and pass it further onto a charge collector. In some embodiments depicted herein, the electrostatic separating member is implemented as a Van de Graaff generator. As will be explained in greater detail below, it can be said that the electrostatic charge separating member together with the motive member 112 and the source of power 114 form an electrostatic generating sub-assembly.

Within embodiments of the present invention, the second body portion 106, effectively, acts as such a charge collector mentioned above. More specifically, within the embodiments of the present invention, at least a portion of the second body portion 106 is implemented as an accumulating member 238. The accumulating member 238 is, in a sense, implemented in the form of at least a portion of the second body portion 106 and is electrically operatively coupled thereto. In embodiments of the present invention, the accumulating member 238 is made from a material selected from a group of (a) conductors with high electrical resistance; and (b) insulators with low dielectric strength, (c) conductors with low electric conductivity. A non-limiting list of examples of such materials that can be used for the accumulating member 238 includes but is not limited to cardboard, wood, silicon, conductive plastic, certain types of plastic foam, paper, nylon, rubber, foam, styrofoam.

Generally speaking the accumulating member 238 acts as a charge collector for accumulating the generated electrostatic charge from the belt 128. To that end, proximate each one of the first roller 124 and the second roller 126, there is provided a respective metal conductive brush, according to the general implementations of the Van de Graaff generator. In the specific embodiment, there is provided a first brush 192 and a second brush 194, which in embodiments are made of metal or any other suitable conductive material.

The first brush 192 that is located proximate to the second roller 126 collects the residual charge and transfers the charge on to the accumulating member 238. When the first body portion 104 is attached with the second body portion 106, i.e. when in the assembled state of FIG. 1, the accumulating member 238 gets into an electric contact with the exposed part of the first brush 192 that collects the residual charge from the belt 128. In other words, the first brush 192 is electrically coupled to the accumulating member 238, when in use. The second brush 194 can be electrically coupled to the gasket 121, in the specific embodiment for grounding through the body of the user or to any other suitable means for grounding, which are by no means limited and will become apparent to those of skill in the art. As such, the second brush 194 is electrically coupled to grounding means to ground the accumulated charge through a body of a user, when in use.

For the purposes of implementing embodiments of the present invention, the accumulating member 238 can be implemented in a shape that facilitates generation of a corona discharge. More specifically, the accumulating member 238 is implemented as having a substantially smooth surface and as having at least one “outlet” with edges that allow visible/active corona discharge to happen. This discharge outlet can be located on the tip and/or side thereof, in the sense creating additional edges on the accumulating member 238 for generating corona discharge, also referred to those by skill in the art as air ionization.

In one example, the shape of the accumulating member 238 can be implemented as a conical shape with an apex point facing upward (i.e. away from the first body portion 104). Alternatively and as depicted in FIG. 1, for example, the accumulating member 238 can be implemented as an elongated cylindrical body, substantially hollow. In yet further alternative implementations the accumulating member 238 can be implemented in a shape much akin to a vacuum cleaner attachment known as a “crevice device” having a cylindrical flattened out top with slightly raised edges.

Furthermore, in accordance with embodiments of the present invention, there is provided an application member 260. In the illustrated embodiment, the application member 260 is implemented as a roller 264. The roller is mounted onto the accumulating member 238 using a support 262. The support 262 comprises leg portion 263 and an insert portion 265. Generally speaking, the support 262 is mounted onto the accumulating member 238 by means of one of insertion into or attachment onto the accumulating member 238. In the specific example to be depicted herein, the insert portion 265 is inserted into the accumulating member 238 to be described in greater detail herein below. It should be noted that in alternative embodiment, the leg portion 263 can be implemented as at least one leg portion 263, i.e. having one or two or more leg portions.

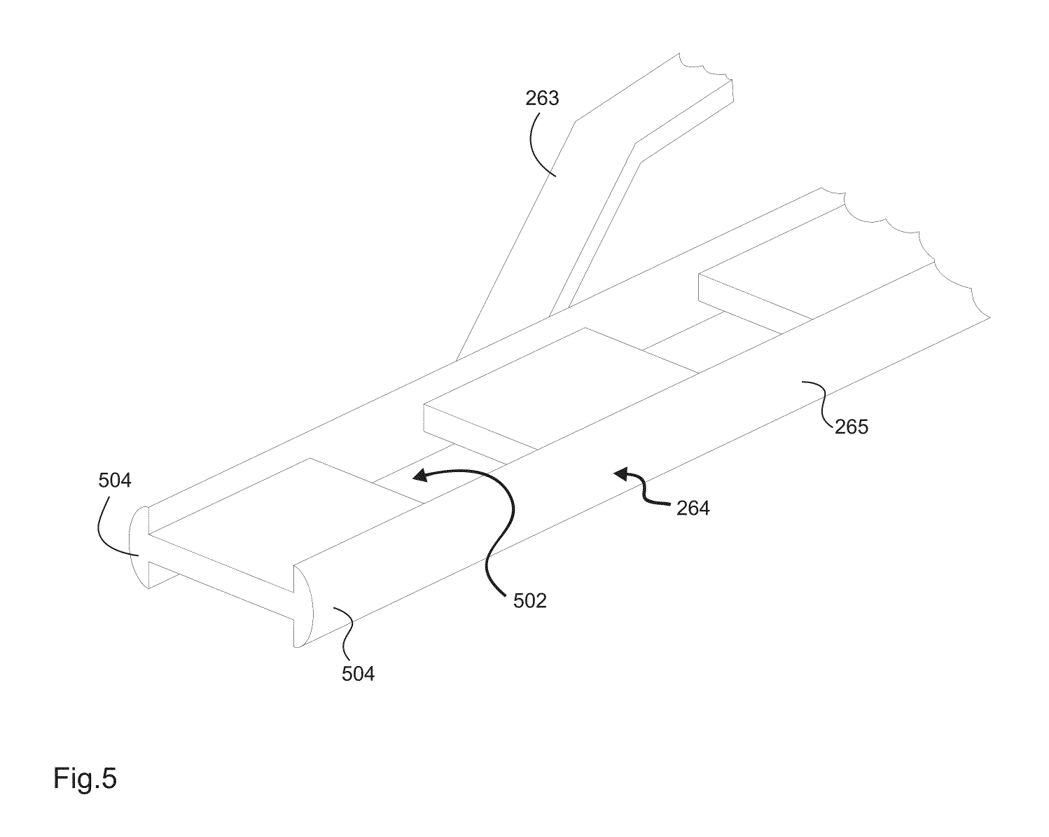

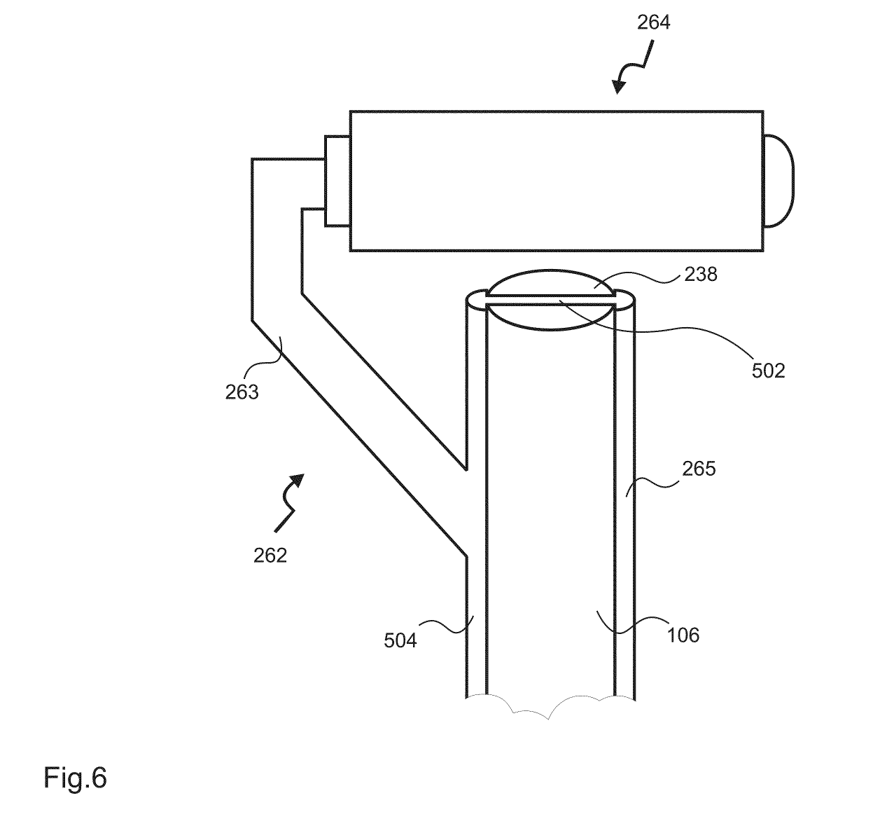

With brief reference to FIG. 5 and FIG. 6 the structure of the support 262 will be described in greater detail, in which FIG. 5 depicts a perspective view of a portion of the support 262 and FIG. 6 depicts a front planar view of the accumulating member 238 and the installed support 262, in accordance with a non-limiting embodiment of the present invention.

The insert portion 265 has a general H-shaped configuration that is dimensioned complementary to the inner hollow configuration of the accumulating member 238. In some embodiments of the present invention, the insert portion 265 may comprise apertures 502, which can be used for light-weighting for example. The insert portion 265 is inserted into the inner hollow space of the accumulating member 238. It is best seen in FIG. 6 that the wings 504 of the insert portion 265 protrude through a slot 267 defined in the accumulating member 238.

The leg portion 263 has a goose-neck shape, one end of which is used to rotatably mount the roller 264 thereon and the second portion is coupled to the insert portion 265. It is noted that in some embodiments of the present invention, the support 262 can be made of plastic, such as but not limited to ABS, PET, PE, LDPE, resin, or acrylic. Generally speaking, within these embodiments, the support 262 is made of material, which will not interfere with the operation of the roller 264, as will be described momentarily.

In alternative embodiments of the present invention, the support 262 can be also made from conductive materials, such as those that are used for the accumulating member 238, for example. Also, it is noted that the support 262 can be implemented in a different form-factor or, put another way, there are other possible implementations for coupling the application member 260 onto the accumulating member 238. For example, the support 262 can have two legs. As another example, the support 262 can be integrally made with the accumulating member 238.

In some embodiments, the outer surface of the roller 264 is made of dielectric material. For example, the outer surface of the roller 264 can be made of soft material, such as but by no means limited to as microfiber, polyester, wool, cotton, foam, or the like. In other embodiments of the present invention, the outer surface of the roller 264 can be made of insulating plastic. Generally speaking, the roller 264 can be made of cardboard, wood, silicon, conductive plastic, certain types of synthetic foam, cotton, polyethylene, polyester, polypropylene, Teflon®, microfiber, wool and the like. In certain non-limiting embodiments of the present invention, the roller 264 can be of a multi-layer structure. For example, an inner layer can be made of a first material (such as plastic) and an outer layer can be made of a second material (such as a soft material, which can be microfiber or polyester fuzz, or synthetic foam.

As is clearly visible in FIG. 3, the application member 260 is spaced apart from an outer edge 242 of the accumulating member 238 by a separating distance “d”. The separating distance “d” is selected such that a proximate end of the application member 260 (i.e. an end of the roller 264 that is at a given time most proximate to the accumulating member 238) is within the electric field of the accumulating member 238 (will be described in greater detail herein below). In a specific embodiment of the present invention, the distance “d” can be 2 mm.

In a specific non-limiting embodiment of the present invention, the diameter of the accumulating member 238 can be 2 cm and the length of the roller 264 can be 7 cm. It is noted that specific dimensions can be different in alternative embodiments of the present invention. It is however noted that the length of the roller 264 is selected such as to receive the electrostatic charge effectively over the whole length of the roller 264. As will be appreciated by those skilled in the art, the roller 264 receives the electrostatic charge over substantially the whole length thereof when the whole length thereof is located within the electric field of the accumulating member 238 or, more precisely, within the strongest part of the electric field of the accumulating member 238. Those skilled in the art will appreciate that selecting too large of a length for the roller 264 may be counter-productive and those skilled in the art will easily be able to select the appropriate length thereof.

Within embodiments of the present invention, when in use and when a charge is accumulated upon the accumulating member 238, as will be described momentarily, the application member 260 (or more specifically a proximate edge thereof) gets charged by means of corona discharge, also known as air ionization. Naturally and as will be appreciated by those skilled in the art, the closer the application member 260 is located relative to the accumulating member 238 (i.e. the shorter the separation distance “d” is), the faster the application member 260 gets electrically charged.

In those embodiments of the present invention, where the support 262 is made of non-conductive materials, the application member 260 gets charged primarily by corona discharge only. In those embodiments, where the support 262 is made of conductive material, the application member 260 gets charged primarily by means of corona discharge and can also secondly be charged by means of electric conduction through the support 262 being implemented of conductive material.

Having described construction of the electrostatic support applicator 100, general operation thereof will now be described in greater detail. When in use (i.e. when the switch button 119 is depressed), with the motive member 112 providing motive power, the first roller 124 is rotated, which in turn drives the belt 128. Recalling that the first roller 124, the second roller 126 and the belt 128 are implemented as an “electrostatic charge separating member”, which is configured to separate/generate the electrostatic charge, the electrostatic charge is generated and accumulated onto the accumulating member 238.

The accumulating member 238 having a shape conducive to generating the corona discharge, the application member 260 is charged by means of corona discharge from the accumulating member 238. This corona discharge transfers the electric charge onto the application member 260 surface. Recalling that the application member 260 is implemented as a roller 264, which roller 264 rotates around a portion of the leg portion 263, at any given time when the roller 264 rotates in use, a given proximate edge of the roller 264 is exposed to the electric field of the accumulating member 238 and, effectively, gets charged. A technical advantage associated with the rotation of the roller 264 can be characterized in the fact that within this embodiment of the present invention, the application member 260 gets charged comparatively quickly and “evenly” with its rotation.

As will be described momentarily, within embodiments of the present invention, when in use, the application member 260 is used to effectively distribute electrostatic charge received from the accumulating member 238 by means of corona discharge onto a material to be removably adhered onto a support surface.

Just for an illustration purpose and not to limit the scope, the material to be adhered can include plastic film, thin insulating foam, paper, or “sandwiches” of materials made of alternating layers of film, or foam, or paper. In a particular embodiment, the electrostatic support applicator 100 can be used to adhere a piece of paper onto a wall by use of an intermediate plastic film. In sense, a conducting wall, an insulating plastic and conducting paper create a sandwich similar to a capacitor which allows it to maintain charge for a substantially long time. It is noted that in alternative embodiments, the paper can adhere to the wall without an intermediate plastic layer, but in this case it is expected that the static charge will quickly dissipate and the paper will fall comparatively quickly, but this can still be used for short-term applications.

When the electrostatic support applicator 100 is used over the material to be adhered, the charge generated by the electrostatic charge separating member, accumulated onto the accumulating member 238 and eventually transferred onto the application member 260 (i.e. the roller 264) eventually gets transferred onto the material by means of rotating the roller 264 over the material. A specific technical advantage attributable to implementing the application member 260 as the roller 264 may include ability to smoothen the material, while charging it, preventing formation of air bubbles. This, in turn, may lead to a comparatively better or long-lasting adhesion between the material and the support surface.

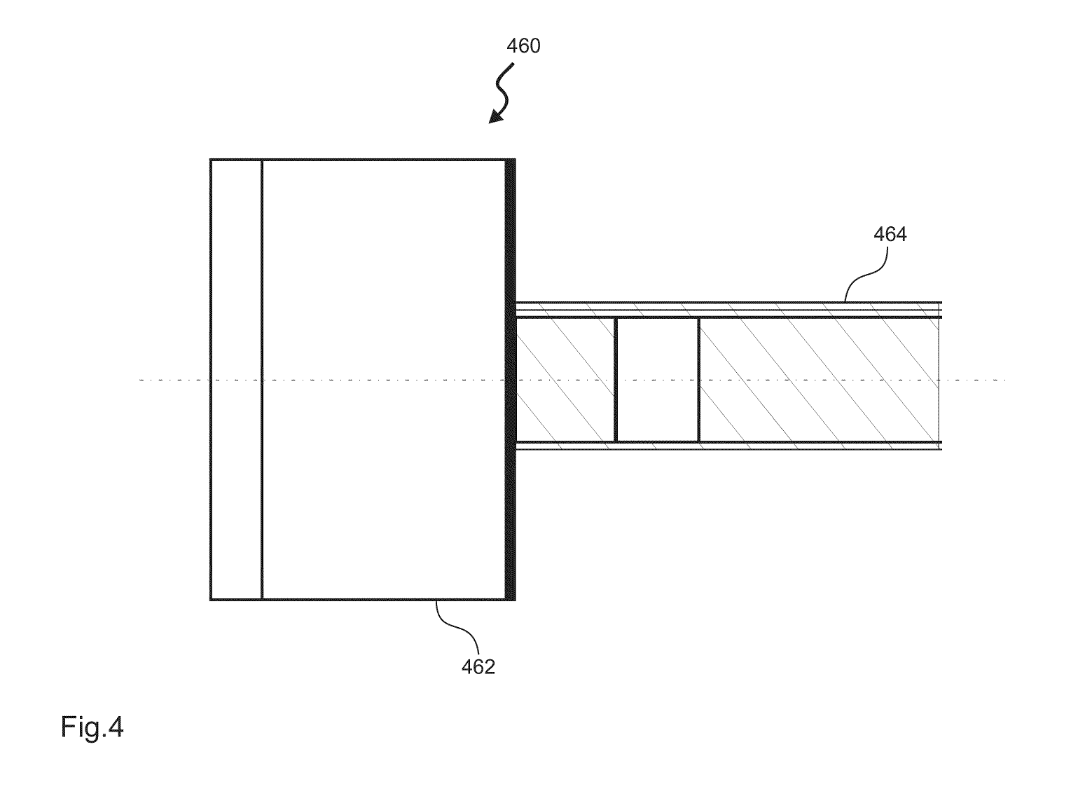

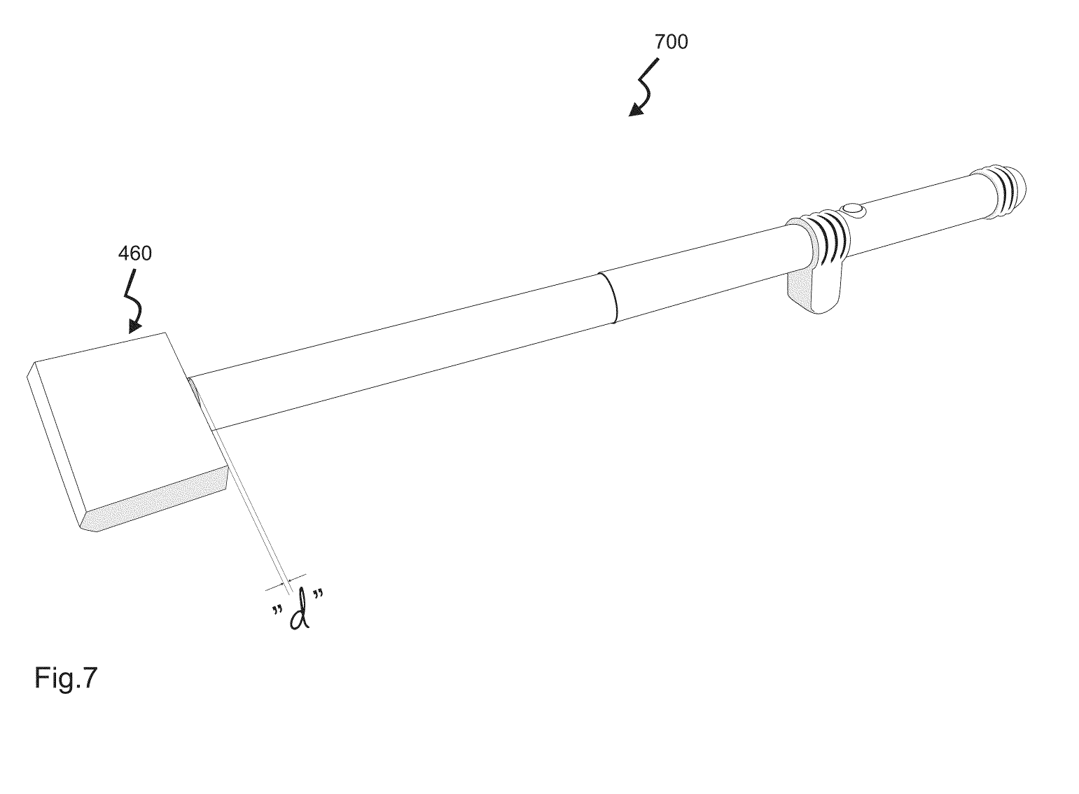

It is noted, however, that in alternative embodiments the application member 260 can be implemented differently. An example of such an alternative implementation is depicted in FIG. 4, which depicts a front cross section of another non-limiting embodiment of an application member 460. The application member 460 is implemented as a flat brush 462, similar to those that are used for localized or hard-to-reach-area painting. The flat brush 462 is coupled to a support 464, which is also configured to be positioned within the accumulating member 238, much akin to the support 262, as is best seen in FIG. 7, which depicts a perspective view of an electrostatic support applicator 700 implemented in accordance with another non-limiting embodiment of the present invention.

The support 464 is positionable within the accumulating member 238, such that a separation distance “d” may be substantially small, such as close to 0 mm (i.e. the flat brush 462 may touch the accumulating member 238), while still allowing for the corona discharge phenomenon. The flat brush 462 can be made of foam or alternatively any other suitable for painter's brush material and the materials that can be used for the roller 264 described above.

It is noted that in these embodiments, the flat brush 462 gets charged primarily by means of the corona discharge from the accumulating member 238. In other embodiments, the support 464 can be made of wood. Within those embodiments, the flat brush 462 gets charged by means of corona discharge, as well as additionally, by means of electric conduction through the support 464 implemented of conductive material (i.e. wood or the like). It is further noted that the flat brush 462 has a structural frame (not separately number), which assists in maintaining the shape thereof.

The implementation of the application member 460 of FIG. 7 are particularly suitable but not limited to the use on non-flat surfaces, such as for example, car windows and the like. Such curved surfaces may not allow effective distribution of charge by rolling and may require the applicator to bend in some fashion to allow even adhesion of the film to the surface and making the air bubbles escape. As such, the implementation of the flat brush 462 may be particularly suitable for removable adhesion of material to curved surfaces, such as for example, a thin film adhesion to a rear window of a car.

Even though the several applications of the electrostatic support applicator have been disclosed above, one should appreciate that the electrostatic support applicator disclosed in accordance with embodiments of the present invention can find a number of other applications. For example, it is contemplated that the electrostatic support applicator can be used to apply temporary tinting films to the car windows for selectively removably tinting same.

In alternative embodiment, the tinting films may be made of different colors, can contain drawing or printings on them, may be adhered one on top of one another creating colorful mosaic windows, or they may be used as an entertaining game for children traveling in a car. Alternatively, electrostatic adhesion of films to the car or house windows can be used for advertisement purposes, such as removable stickers to vote for a certain political figure, or simply state on the rear car window messages such as “Just Married!” or alike. In general this allows personalization of a person's car or house windows.

Alternatively, the electrostatic support applicator can be used to selectively darken a room in the house, by releasably applying a tinting film onto a house or apartment window. Numerous other applications around the house or a commercial establishment are possible (such as but not limited to: applying decoration on walls or windows, preparing party rooms, creating memo boards, hanging paper pictures, photos, magazine cut outs, company logos and other promotional information in public places, hotels, etc.)

Accordingly, the electrostatic support applicator 100 described above, in accordance with various embodiments of the present invention, allows for effective transfer of electrostatic charge onto the material being supported on a support surface, while allowing to evenly distribute the charge over large surfaces, while flattening out the material being treated, effectively preventing formation of air bubbles.

Some of the technical effects of embodiments of the present invention, includes provision of a simple, comparatively low-cost device that can be used to temporarily adhere items (such as, paper items and the like) to support structures (such as, walls and glass) in a mess-free fashion without using Scotch® tape or push pins and alike. Another technical effect of embodiments of the present invention, includes provision of a device that is safe for anyone to use (including, adults, children and elderly people) and which does not rely on or requires securing the insulation around the conducting stem, as the charging of the applicator member from the accumulator member is done via corona discharge. Another technical effect of embodiments of the present invention may include substantial prevention of accidental electric discharge from the applicator member, which can be unpleasant to people. Another technical effect of embodiments of the present invention includes provision of an apparatus that can be used to transfer charge onto a relatively large surface of the material being treated, while flattening the material and effectively preventing formation for air bubbles. It should be noted that not each and every technical effect needs to be enjoyed in each and every embodiment of the present invention.

It should be noted that in some embodiments of the present invention, the electrostatic support applicator 100 can be sold as a whole. In other embodiments, a retrofit kit can be sold. A retrofit kit may include the above mentioned application member 260, 460 with a suitable support that can be mounted by a user onto a suitable accumulator, such that the application member 260, 460 can be charged by corona discharge.

The description of the embodiments of the present inventions provides examples of the present invention, and these examples do not limit the scope of the present invention. It is to be expressly understood that the scope of the present invention is limited by the claims only. The concepts described above may be adapted for specific conditions and/or functions, and may be further extended to a variety of other applications that are within the scope of the present invention. Having thus described the embodiments of the present invention, it will be apparent that modifications and enhancements are possible without departing from the concepts as described.

Therefore, what is to be protected by way of letters patent are limited only by the scope of the following claims:

1. An electrostatic support applicator comprising:
a body including:
a first body portion and a second body portion;
the first body portion including an electrostatic generating sub-assembly;
the second body portion being implemented as an accumulating member for accumulating electrostatic charge; and
an application member mounted onto said accumulating member and spaced away from said accumulating member by a separating distance “d”, said separating distance “d” being within an electric field of said accumulating member such that said application member gets charged from said accumulating member, when in use, by means of corona discharge.

2. The electrostatic support applicator of claim 1, wherein said accumulating member is made from a material selected from (a) conductors with high electrical resistance; or (b) insulators with low dielectric strength; (c) conductors with low electric conductivity.

3. The electrostatic support applicator of claim 1, wherein said accumulating member is implemented in a shape that facilitates corona discharge generation.

4. The electrostatic support applicator of claim 1, wherein said application member comprises a roller.

5. The electrostatic support applicator of claim 4, wherein said roller is made of a material selected from: cardboard, wood, silicon, conductive plastic, certain types of synthetic foam, cotton, polyethylene, polyester, polypropylene, Teflon®, microfiber and wool.

6. The electrostatic support applicator of claim 4, wherein at least an outer surface of said roller is made of soft material.

7. The electrostatic support applicator of claim 1, wherein said application member comprises a flat brush.

8. The electrostatic support applicator of claim 1, wherein said application member is mounted to accumulating member via a support.

9. The electrostatic support applicator of claim 8, wherein said support is made of material that does not interfere with charging of the application member via corona discharge.

10. The electrostatic support applicator of claim 8, wherein said support is coupled to the accumulating member by one of insertion or attachment onto the accumulating member.

11. The electrostatic support applicator of claim 9, wherein said support comprises at least one leg portion and an insert portion.

12. The electrostatic support applicator of claim 11, wherein said leg portion is configured to rotatably mount the application member and wherein said application member is implemented as a roller and wherein said leg portion is configured to mount said roller in a rotatable manner.

13. The electrostatic support applicator of claim 1, wherein said application member gets primarily charged through the corona discharge; and wherein the application member is mounted onto the accumulating member through a support made of eclectically conductive material and wherein the application member gets secondarily charged through the support.

14. The electrostatic support applicator of claim 11, wherein said insert portion is positionable within a hollow interior of the second body portion.

15. The electrostatic support applicator of claim 1, wherein said electrostatic generating sub-assembly comprises:
an electrostatic charge separating member for generating an electrostatic charge;
a motive member and a source of power for powering the motive member 112, the motive member and the source of power for providing motive to the electrostatic charge generating member.

16. The electrostatic support applicator of claim 15, wherein said electrostatic charge separating member is implemented as a Van de Graaff generator.

17. The electrostatic support applicator of claim 16, wherein said electrostatic charge separating member comprises:
a first roller, a second roller, and a belt therebetween, wherein the first roller is moved, in use, by the motive member;
a respective first and second brushes provided close to each of the first roller and the second roller;
the first brush electrically coupled to the accumulating member;
the second brush being electrically coupled to grounding means to ground an accumulated charge through a body of a user, when in use.

18. The electrostatic support applicator of claim 2, wherein the voltage required for the electrostatic support applicator is at least 2 kV.

19. The electrostatic support applicator of claim 18, wherein the voltage required for the electrostatic support applicator is at least 10 kV.

20. A retrofit kit comprising:
an application member and a support;
the support for mounting the application member, in use, onto an electrostatic charge separating member having a portion conducive to generating corona discharge, in use, such that the application member is spaced away from the accumulating member by a separating distance “d”, said separating distance “d” being within an electromagnetic field of the accumulating member such that said application member gets charged from the accumulating member, when in use, by means of corona discharge.
